(19) United States
(12) Patent Application Publication
(10) Pub. No.: US 2006/0003062 A1
(43) Pub. Date: Jan. 5, 2006

(54) Method for packaging perishable products and package for perishable products

(76) Inventor: Alexandre Paviot, Lyon (FR)

Correspondence Address: DENNISON, SCHULTZ, DOUGHERTY & MACDONALD, 1727 KING STREET, SUITE 105, ALEXANDRIA, VA, 22314, US

(21) Appl. No.: 10/530,440

(22) PCT Filed: Oct. 8, 2003
(86) PCT No.: PCT/FR03/02958

§ 371 Date: Jun. 22, 2005

(30) Foreign Application Priority Data
Oct. 8, 2002 (FR) 02 12 459

(51) Int. Cl. A23B 4/00

(52) U.S. Cl. 426/397

(57) ABSTRACT

This invention relates to a conditioning method for perishable products (2) with a preservation temperature, using a heat sealable packaging (1) with two transverse edges (11, 12) and two longitudinal edges (9). According to this invention, it comprises the following steps:
make a heat sealable packaging comprising a central compartment (5) bonded with at least one lateral compartment (6), the compartments (5, 6) being sealed on three of their sides,
place a means (8) in each lateral compartment (6) for keeping the perishable product (2) at its preservation temperature,
put the perishable product (2) inside the central compartment (5),
and seal the fourth side of the compartments (5, 6) so as to simultaneously close the compartments (5, 6) so as to form a sealed packaging with a central compartment (5) or leak tight with respect to each lateral compartment.

This invention relates to the technical field of conditioning of perishable products in the general sense, for example such as pharmaceuticals, food or similar products. The purpose of the invention applies particularly to the technical field of packaging products on their place of sale and/or conditioning and particularly food products sold retail, wholesale or partly wholesale.

There are many types of packaging according to the state of the art, particularly for conditioning of food products. For example, patent FR 2 775 252 proposes to use a wrapping at least partly composed of a heat sealable material. This wrapping is composed of two superposed composite sheets assembled at their longitudinal edges (for example by bonding or sealing). Each composite sheet comprises an external layer of aluminium, an internal layer of low density polyethylene and a layer of paper covered with a layer of low density polyethylene. This wrapping packaged in rolls is designed to be cut on the place of use to a length slightly greater than the length of the product to be packaged. Preferably, one end of the wrapping is cut and sealed simultaneously by heat sealing so as to make a bag. Then, after the product to be conditioned has been inserted into the bag made in this way, the other end of the wrapping is heat sealed so as to obtain a sealed packaging.

Such wrapping for packaging is particularly useful for packaging of fresh or frozen products such as fish or meat when these products are sold retail, wholesale or partly wholesale. However, transport between the place of sale and the place of storage of perishable food products may be relatively long, which introduces a problem in terms of preservation quality, for example for a fresh product. Similarly, this type of packaging is incapable of keeping a food product, for example such as grilled meat, at a temperature above ambient temperature for a long period.

In a different technical field, namely preservation of food products by refrigeration, document JP 06 18 34 63 proposed a packaging for a frozen product composed of two adjacent bags each provided with filling holes for water. The frozen product is inserted inside a bag and the two bags are filled with water, and the two bags are then sealed before being frozen.

This type of packaging is not suitable for keeping a food product outside a refrigerated space. Furthermore, this type of packaging requires that the product should be in contact with water and/or ice. In other words, a food product cannot be preserved under good conditions by such packaging placed in an environment at ambient temperature.

Therefore, there is a need to have a technique for quickly and easily packaging a perishable product while keeping it under temperature conditions adapted to its preservation nature.

Therefore the purpose of the invention is to satisfy this need by proposing a method for simple and fast conditioning of perishable products while keeping the product at a preservation temperature adapted to packaged products.

Therefore, the purpose of the invention is a method to be used for perishable products with a preservation temperature, using a heat sealable packaging with two transverse edges and two longitudinal edges, comprising the following steps:
make a heat sealable packaging comprising a central compartment bonded with at least one lateral compartment, the compartments being sealed on three of their edges,
place a means in each lateral compartment for keeping a perishable product at its preservation temperature,
put the perishable product inside the central compartment,
and seal the fourth side of the compartments so as to simultaneously close the compartments so as to form a sealed packaging with a central compartment sealed with respect to each lateral compartment.

Another purpose of the invention is to propose a heat sealable packaging for conditioning of perishable products, particularly food and similar products with two transverse edges and two longitudinal edges, characterized in that it comprises at least three superposed heat sealable composite sheets, two inner sheets that will form a central compartment between them in which the perishable products will be contained, an outer sheet forming a leak tight thermal barrier that will work with a first inner sheet to form a lateral compartment to contain a means of holding the said perishable product at its preservation temperature.

Another purpose of the invention is to propose a packaging designed for easy opening even by a user with wet hands or wearing gloves, inside which the product to be packaged can be inserted.

To achieve this objective, the packaging according to the invention is characterised in that at least each heat sealable layer forming the inner surface of the central compartment has a DIN 53108 BENDTSEN roughness less than or equal to 1200 ml/min and in that together the heat sealable layers have a coefficient of friction less than or equal to 0.5, to enable easy opening of the central compartment according to standard DIN 53 375.

Various other characteristics will become clear from the description given below with reference to the attached drawings that contain non-limitative examples of embodiments of the subject of the invention.

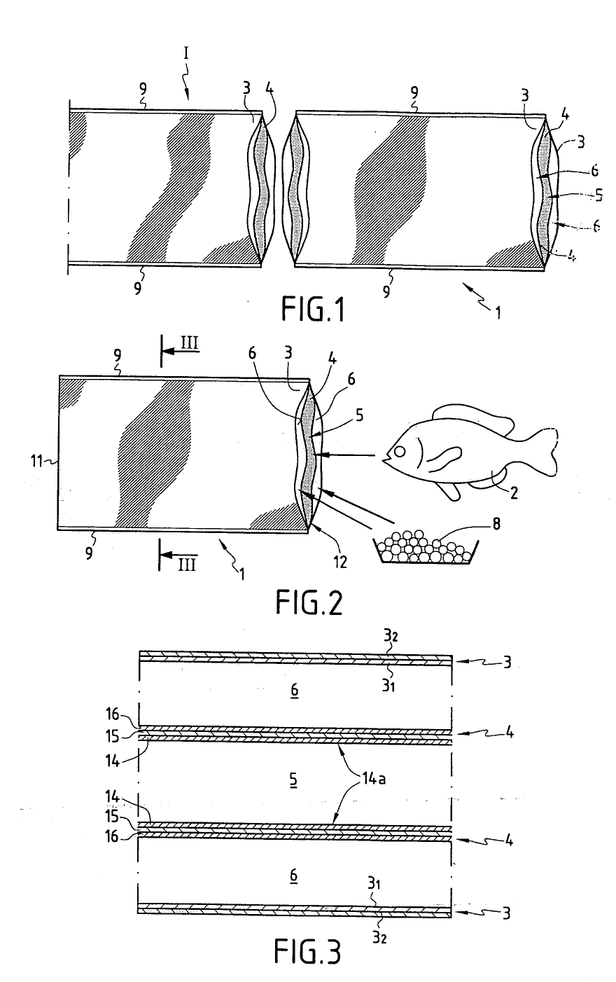

FIG. 1 shows a top view illustrating an example embodiment of a packaging according to the invention.

FIG. 2 shows a packaging according to the invention ready for conditioning of a product.

FIG. 3 shows a view approximately along lines III-III in FIG. 2 showing a partial section through a packaging according to the invention at large scale.

As is clear particularly in FIGS. 1 to 3, the purpose of the invention relates to a packaging 1 adapted to condition perishable products 2 in the general sense such as hot or cold food products for example such as fish or meat, or even pharmaceutical or veterinary products. Packaging 1 according to the invention is composed of at least three, and for example (as shown) four superposed heat sealable composite sheets 3, 4 with a parallelepiped shape with dimensions adapted to the size of the product 2 to be packaged.

Packaging 1 thus comprises at least one, and in the example shown two heat sealable outer composite sheets 3 each forming a leak tight thermal barrier. For example, each external heat sealable composite sheet 3 is composed of:
a composite comprising paper and a plastic material such as polyethylene, polypropylene, polyester, etc.,
and/or paper (such as in body heat sealable paper) and a heat sealable paper complex,
and/or all materials coated on one or both faces, with wax, paraffin, varnish or hot bond lacquer.

As shown diagrammatically in FIG. 3, each heat sealable outer composite sheet 3 comprises an inner layer 3₁ made up as described above.

According to another preferred embodiment, each outer composite sheet 3 comprises an aluminium layer 3₂ on the face delimiting the outside of the packaging, preferably covered with a varnish for printing purposes.

Packaging 1 also comprises two so-called inner heat sealable composite sheets 4 placed between the two outer sheets 3. The two inner sheets 4 delimit a central compartment 5 between them into which the product 2 will fit, while each inner sheet 4 cooperates with an opposite outer sheet 3 to delimit a lateral compartment 6, into which a means 8 will be placed holding the perishable product 2 at its preservation temperature. Note that these means 8, adapted to keep the perishable product 2 at its storage temperature, are composed either of a thermal insulation between the perishable product 2 and the outside, or a cold or heat accumulator depending on the nature of the packaged product 2. It must be considered that this means 8 thus prevents the perishable product 2 from losing its energy (heat or cold) or provides additional energy (heat or cold) such that the perishable product 2 can be kept at an acceptable preservation temperature.

As is clear more precisely in FIG. 2, in the example shown, the four sheets 3, 4 are assembled together at their longitudinal edges by a mechanical assembly, for example by bonding or sealing. A transverse seal connecting the two longitudinal edges 9 is made on a transverse edge 11 of the packaging which is thus in a position ready for use in that the central compartment 5 and the two lateral compartments 6 are opened at the other opposite transverse edge 12 providing access to the inner volume of the three compartments 5, 6.

Packaging 1 is thus ready to contain a means 8 of holding the temperature in the lateral compartments 6 and the product 2 to be packaged in the central compartment 5. The packaging 1 is then sealed on its transverse edge 12. Packaging 1 thus has three compartments 5, 6 that are completely sealed with respect to each other. The central compartment 5 contains the product 2 while the lateral compartments 6 on each side keep the product 2 at a preservation temperature adapted to the packaged product. For packaging of fresh products such as fish, the temperature holding means 8 may consist of a cold accumulator such as ice enclosed with air in each lateral compartment 6. Each lateral compartment 6 thus forms a thermal barrier with regard to the outside so as to keep the food product at a low temperature enabling transport of the packaging within a suitable preservation temperature.

Obviously, it would be possible to use any type of cold or heat storage materials such as gels, bulk ice or packaged ice or any other type of materials or components creating heat or cold. According to another characteristic of the invention, the accumulator could be associated with an absorbent material suitable for taking account of the state change of the accumulator related to a change in its temperature while keeping its consistency approximately constant.

Similarly, the means of holding the temperature 8 may consist of a thermal insulation means such as air or insulating bulk or board materials. In the above description, the packaging 1 comprises two lateral compartments 6 extending on each side of the central compartment 5. Obviously, the packaging can include a single lateral compartment 6 adjacent to the central compartment 5.

The method for packaging a perishable product 2 is a direct result of the above description.

FIG. 1 illustrates an example embodiment using a packaging composed of a wrapping cut-out from a wrapping I generally supplied in rolls. In the example shown, this wrapping comprises four superposed sheets 3, 4 that are assembled along their longitudinal edges 9. This wrapping is cut to the required length to contain a food product 2 such as fish. Preferably, when the wrapping I is cut to form the packaging 1, a transverse seal connecting the longitudinal edges is made on the transverse edge 11 of the heat sealable composite sheets 3, 4.

As is clearer in FIG. 2, the packaging 1 is thus in the form of a bag that could be opened at the transverse edge 12 providing access to the inner volume of the three compartments 5, 6. The food product 2 is placed in the central compartment 5 and a means of holding the temperature 8 is inserted in each lateral compartment 6. Obviously, the means of holding the temperature 8 may be inserted in the lateral compartments 6 before or after the product 2 is inserted in the central compartment 5. A seal is then made on the fourth side of the compartments 5, 6, in other words along the transverse edge 12, so as to form three compartments 5, 6 completely leak tight from the outside. The compartments 5, 6 are thus simultaneously sealed by one seal made along the fourth side.

As is clear from the above description, the process for packaging a product 2 associated with means of holding it at an appropriate temperature, forms a single easily performed operation. According to the example embodiment described above, the user simply cuts the required length from a roll of wrapping, to condition the product 2. Advantageously, the packaging 1 is cut at the same time as the transverse edge cut from the wrapping roll is sealed. The product 2 and the means of holding the temperature 8 are then inserted inside compartments 5 and 6 respectively, and these three compartments 5, 6 are sealed simultaneously by a seal on the other transverse edge.

Thus, the packaging 1 contains the product 2, and also a means of holding the temperature 8, preferably extending on each side of the product 2 to keep it at its ideal temperature during transport. The composite sheets 3, 4 are leak tight, and form a means of obtaining a packaging 1 comprising a central compartment 5 that is leak tight with regard to the lateral compartments 6 and these lateral compartments are leak tight with regard to the outside.

In the example described above, the wrapping 1 comprises two pairs of composite sheets 3, 4 such that one is superposed above the other, and assembled along their two longitudinal edges 9. Obviously, it would be possible to make a pair using a single composite sheet without sealing or bonding or with a single assembly line obtained by folding the sheet and sealing, bonding or mechanically assembling the free edges opposite the fold.

Note that according to another embodiment, the packaging 1 according to the invention may be made up from wrapping comprising a lateral compartment 6 composed of an inner composite sheet 4 and an outer composite sheet 3. This wrapping is folded along a transverse edge and is assembled along at least two longitudinal edges to form the central compartment 5 and the two lateral compartments 6. According to this variant embodiment, the packaging 1 is made from a wrapping cut to a length equal to approximately twice the size of the product 2 to be packaged, since the wrapping is folded on itself. Note that there may or may not be a seal line or a bond line along the fold line, so that it allows or prevents the lateral compartments 6 from communicating with each other.

According to one preferred characteristic of the invention, each inner composite sheet 4 comprises at least one inner layer 14 made of a heat sealable material with an outer surface 14a cooperating to form the inner surface of the central compartment 5 as is clearly visible in FIG. 2. Thus, each composite sheet 4 has a layer 14 made of a heat sealable material, the layers facing each other at their outer surface 14a, for heat sealing of the two sheets 4 to each other. Thus, since the inner layers 14 made of a heat sealable material are in contact with each other, applying a local pressure between the sheets 4, for example at the transverse edges of the wrapping, plus local heating provides a means of sealing the sheets together.

Therefore, it should be understood that each inner composite sheet 4 comprises at least one layer 14 of a heat sealable material that is preferably a plastic material. Advantageously, each layer of heat sealable plastic material 14 is deposited on a paper layer 15, preferably with high mechanical strength. Preferably, each inner composite sheet 4 also comprises an outer layer 16 made of a heat sealable material covering the layer of paper 15.

According to another preferred characteristic embodiment that will be described in the remainder of the description, the material from which the heat sealable plastic inner layer 14 and outer layer 16 are composed is a low density polyethylene (LDPE). Obviously, it will be possible to make the heat sealable material inner layer 14 and outer layer 16 using a different material, for example such as polypropylene, glue or heat sealable wax, or a layer of heat sealable material deposited by dispersion, coating or impregnation.

Similarly, as already described, each outer sheet 3 comprises an inner layer 3₁ made of a heat sealable material that may be different from or identical to the material used to make the layer 14, 16 of inner sheets 4.

According to another characteristic of the invention, the inner heat sealable layers 14 delimiting the inner surface of the central compartment 5, and/or at least one or possibly both of the outer layers 16 and the adjacent inner layer(s) 3₁, have characteristics determined to facilitate opening of the central compartment and/or one of the two lateral compartments 6. Thus, the roughnesses of the heat sealable material inner layer 14 and/or heat sealable material outer layer 16 and the heat sealable material inner layer 3₁ determined according to the DIN 53 108 BENDTSEN technique are less than or equal to 1200 millilitres per minute, and according to one advantageous characteristic, between 800 and 1200 ml/min and preferably of the order of 910 ml/min.

The roughness can be obtained on each heat sealable layer 14 and/or 16 and 3₁, for example by using a rough heavy cylinder coming into contact with the outer surface of the heat sealable layer. For example, the heat sealable layer is a layer of heat sealable plastic material made by extrusion of EAA [(Ethylene-Acrylic-Acid) additives for LDPE] type copolymers and all types of LDPE. The invention includes all types of extrusion and coextrusion by coating.

According to another characteristic of the invention, the coefficient of friction between heat sealable layers 14 and/or 16 and 3₁ is less than or equal to 0.5 and is preferably between 0.25 and 0.35, and even better of the order of 0.3 according to standard DIN 53 375.

A coefficient of friction of this magnitude may advantageously be obtained by extrusion or coextrusion of specific polymers (some types of modified LDPEs) and/or by the addition of at least one friction reducing additive, for example such as product reference 252 CH marketed under the commercial trademark EXXON.

The combined use of heat sealable layers 14 and/or 16 and 3₁ with a specific roughness associated with a determined coefficient of friction guarantees easy opening of each compartment 5, 6. This type of packaging 1 can easily be opened even by a person with wet hands or wearing gloves, starting from its free edges, simply by a rubbing action on the two sheets 4. This type of easy opening is possible due to this “easily opened wrapping” invention and by determining values of the friction, roughness and slipping properties of the heat sealable layers 14 one against the other. Similarly, if the roughness of inner layer 3₁ of one or both outer sheets 3 and the outer layer 16 adjacent to one or both inner sheets 4 is equal to this specific value combined with a determined coefficient friction, the lateral compartment(s) 6 can easily be opened.

1. Conditioning method for perishable products (2) with a preservation temperature, using a heat sealable packaging (1) with two transverse edges (11, 12) and two longitudinal edges (9), characterised in that it comprises the following steps:
make a heat sealable packaging comprising a central compartment (5) bonded with at least one lateral compartment (6), the compartments (5, 6) being sealed on three of their sides,
place a means (8) in each lateral compartment (6) for keeping the perishable product (2) at its preservation temperature,
put the perishable product (2) inside the central compartment (5),
and seal the fourth side of the compartments (5, 6) so as to simultaneously close the compartments (5, 6) so as to form a sealed packaging with a central compartment (5) sealed with respect to each lateral compartment.

2. Method according to claim 1, characterised in that a heat sealable packaging is made which comprises two lateral compartments (6) extending on each side of the central compartment (5).

3. Method according to claim 1, characterised in that it consists of placing a means for holding the temperature (8) in each lateral compartment (6), namely a cold or heat accumulator.

4. Method according to claim 1, characterised in that it consists of placing a means in each lateral compartment (6) for holding the temperature (8), namely a thermal insulation means.

5. Conditioning method according to claim 2, characterised in that it consists of making the heat sealable packaging (1) from a wrapping (I) comprising a central compartment (5) extending between two lateral compartments (6), cut out to an appropriate length to contain the perishable product (2) to be packaged, and assembled along a transverse edge such that the three compartments (5, 6) are accessible from the opposite transverse edge.

6. Conditioning method according to claim 2, characterised in that it consists of making the heat sealable packaging (1) from a wrapping (I) comprising a lateral compartment (6), folded along a transverse edge and assembled along at least two longitudinal edges to form the central compartment (5) and the two lateral compartments (6).

7. Conditioning method according to claim 6, characterised in that it consists of making the heat sealable packaging (1) from a wrapping cut to a length equal to approximately twice the size of the perishable product (2) to be packaged.

8. Conditioning method according to claim 3, characterised in that it consists of placing ice inside the lateral compartments as a cold accumulator (8).

9. Heat sealable packaging for perishable products (2) particularly food or similar, with two transverse edges (11, 12) and two longitudinal edges (9) characterised in that it comprises at least three superposed heat sealable composite sheets (3, 4), two inner sheets (4) being designed to delimit a sealed central compartment (5) between them in which the perishable product (2) will fit, an outer sheet (3) forming a leak tight and thermal barrier that will work with a first inner sheet (4) to form a lateral compartment (6) to contain a means (8) of holding the said perishable product (2) at its preservation temperature.

10. Heat sealable packaging according to claim 9, characterised in that it comprises a fourth superposed heat sealable composite sheet (3) called the outer sheet, forming a leak tight and thermal barrier that will work with the second inner sheet (4) to form a lateral compartment (6) to contain a means (8) of holding the said perishable product (2) at its preservation temperature, such that there is a lateral compartment (6) on each side of the central compartment (5).

11. Heat sealable packaging according to claim 10, characterised in that it is a wrapping (I) comprising a central compartment (5) located between two lateral compartments (6).

12. Heat sealable packaging according to claim 11, characterised in that it is a wrapping (I) assembled at its longitudinal edges (9) and cut out to a required length to contain the perishable product (2) to be packaged.

13. Heat sealable packaging according to claim 12, characterised in that the wrapping (I) is sealed along a transverse edge (11) such that the three compartments (5, 6) are accessible from the opposite transverse edge (12).

14. Heat sealable packaging according to claim 13, characterised in that the wrapping (I) is sealed along its second transverse edge (12) after the perishable product (2) has been inserted in the central compartment (5) and the means (8) for holding the temperature have been inserted in the lateral compartments (6).

15. Heat sealable packaging according to claim 9, characterised in that it is a wrapping (I) comprising a lateral compartment folded along a transverse edge and assembled along the two longitudinal edges.

16. Packaging according to claim 9, characterised in that each outer sheet (3) is made from a paper/plastic composite material.

17. Packaging according to claim 16, characterised in that each outer sheet (3) comprises an outer aluminium layer (3₂).

18. Packaging according to claim 9, characterised in that each composite inner sheet (4) comprises a heat sealable outer layer (16) and a paper layer (15) covered with a heat sealable layer (14) forming the inner surface of the central compartment (5).

19. Packaging according to claim 9, characterised in that at least each heat sealable layer (14) forming the inner surface of the central compartment (5) has a DIN 53108 BENDTSEN roughness less than or equal to 1 200 ml/min and in that together the heat sealable layers (14) have a coefficient of friction less than or equal to 0.5, to enable easy opening of the central compartment (5).

20. Packaging according to claim 18, characterised in that at least one of the outer layers (16) of the inner composite sheet (4) and one inner layer (31) of the adjacent outer sheet (3) have a DIN 53108 BENDTSEN roughness less than or equal to 1200 ml/min and in that together the outer layer (16) and the inner layer (3₁) have a coefficient of friction less than or equal to 0.5, to enable easy opening of the corresponding lateral compartment (6).

21. Packaging according to claim 19, characterised in that each heat sealable layer (14), forming the inner surface of the central compartment (5), and/or the outer layer (16) of at least one inner composite sheet (4) and the inner layer (3₁) of the adjacent outer sheet (3) have a DIN 53108 BENDTSEN roughness between 800 and 1200 ml/min and preferably of the order of 910 ml/min.

22. Packaging according to claim 21, characterised in that the heat sealable layers (14), forming the inner surface of the central compartment (5), and/or the outer layer (16) of at least one inner composite sheet (4) and the inner layer (3₁) of the adjacent outer sheet (3) together have a coefficient of friction between 0.25 and 0.35, preferably of the order of 0.3.

23. Packaging according to claim 9, characterised in that each heat sealable layer (14, 16, 3₁) is made by extrusion and/or coextrusion of polymers.

24. Packaging according to claim 9, characterised in that each heat sealable layer (14, 16, 3₁) includes at least one friction reducing additive.

25. Packaging according to claim 9, characterised in that each material from which the heat sealable layer (14, 16, 3₁) is made is a plastic material, and preferably a low density polyethylene.
